(19) United States
(12) Patent Application Publication
(10) Pub. No.: US 2008/0197832 A1
(43) Pub. Date: Aug. 21, 2008

(54) Electrical Leakage Detection Apparatus and Electrical Leakage Detection Method For Fuel Cell

(75) Inventor: Tatsuaki Yokoyama, Shizuoka-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/662,300

(22) PCT Filed: Sep. 27, 2005
(86) PCT No.: PCT/IB05/02848

§ 371 Date: Mar. 9, 2007

(30) Foreign Application Priority Data
Sep. 28, 2004 (JP) 2004-281652

(51) Int. Cl. H01M 8/04

(52) U.S. Cl. 324/72

(57) ABSTRACT

An electrical leakage detection apparatus for a fuel cell includes a voltage detector that detects a voltage applied to coolant in a fuel cell; an electrical leakage determining portion that determines that electrical leakage has occurred when the voltage detected by the voltage detector is equal to or higher than a voltage threshold value; a resistance value detector that detects a resistance value of the coolant in the fuel cell; and a correction portion that corrects the voltage threshold value such that the voltage threshold value is increased with an increase in the resistance value detected by the resistance value detector.

### BACKGROUND OF THE INVENTION

1. Field of the Invention

The invention relates to detection of electrical leakage in a fuel cell.

2. Description of the Related Art

A fuel cell generates electric power using chemical reaction between hydrogen and oxygen, and is a promising new-generation energy power for a vehicle or the like. In such a fuel cell for a vehicle, electric power generation portions called cells are connected in series so that electric power is generated at a high voltage, for example, 300 volts to 400 volts. Therefore, when the fuel cell is installed in a vehicle, it is important to take a measure against electrical leakage. As the measure against electrical leakage, for example, a terminal of a high voltage system and input/output cables that extend from the fuel cell are insulated.

Also, in the fuel cell, coolant is used in order to prevent electric power generation efficiency from being decreased due to generation of heat when chemical reaction between hydrogen and oxygen occurs. The coolant is circulated in the fuel cell. The coolant flows for example, between a radiator and the fuel cell through a metal pipe. Since metal ions and the like gradually leak out of the metal pipe, an electric conductivity of the coolant is increased. That is, as the coolant is used, an electric resistance thereof is reduced, and electric current becomes likely to flow in the coolant. Thus, even if the output cable and the like which extend from the fuel cell are insulated, electrical leakage may occur due to the coolant and the like.

Japanese Patent Application Publication No. JP 2004-055384 A discloses a technology for detecting such electrical leakage caused by coolant in a fuel cell. In the technology, since a high voltage occurs in an intermediate electric potential portion of the fuel cell due to leakage current in the coolant when electrical leakage occurs, electrical leakage is detected by measuring a voltage at the intermediate electric potential portion of the fuel cell.

In addition, Japanese Patent Application Publication No. JP 2002-216825 A discloses a technology in which leakage current in coolant is detected by measuring a voltage of the coolant in a fuel cell stack using a voltmeter. Also, Japanese Patent Application Publication No. JP 4-301376 A discloses a technology for detecting leakage current which flows due to insulation failure between an electric power generation portion of a fuel cell and a manifold provided on a side surface thereof.

However, in the aforementioned technologies, in a case where a resistance value between the intermediate electric potential portion of the fuel cell and a ground is changed due to a change in the electric conductivity of the coolant in the fuel cell, even when the detected voltage values are the same, actual leakage current values may be different. That is, if the coolant is deteriorated and the resistance value is decreased, only large leakage current can be detected. Meanwhile, when the resistance value of the coolant is high, for example, immediately after the coolant is exchanged, even small leakage current is detected and it is determined that an abnormality has occurred.

### SUMMARY OF THE INVENTION

It is an object of the invention to provide an electrical leakage detection apparatus and an electrical leakage detection method which accurately detect electrical leakage in a fuel cell.

According to a first aspect of the invention, an electrical leakage detection apparatus for a fuel cell includes a voltage detector that detects a voltage applied to coolant flowing in a fuel cell; and a resistance value detector that detects a resistance value of the coolant in the fuel cell. The electrical leakage detection apparatus further includes an electrical leakage determining portion that determines that electrical leakage has occurred when the voltage detected by the voltage detector is equal to or higher than a voltage threshold value; and a correction portion that corrects the voltage threshold value such that the voltage threshold value is increased with an increase in the resistance value detected by the resistance value detector.

According to the aforementioned aspect, the voltage threshold value is corrected based on the resistance value of the coolant detected by the resistance value detector. When the voltage detected by the voltage detector is equal to or higher than the voltage threshold value, it is determined that electric leakage has occurred. With this configuration, it is possible to detect electrical leakage using the voltage threshold value that is corrected according to a change in the resistance value of the coolant, which is caused by deterioration of the coolant.

In the electrical leakage detection apparatus according to the aforementioned aspect of the invention, the resistance value detector may detect the resistance value of the coolant in the fuel cell before the fuel cell generates electric power. Thus, the resistance value detector can accurately detect the resistance value of the coolant, irrespective of a high voltage generated by the fuel cell.

Further, in the electrical leakage detection apparatus according to the aforementioned aspect of the invention, the correction portion may calculate the voltage threshold value based on the resistance value detected by the resistance value detector and a predetermined leakage current value. Thus, it is possible to detect electrical leakage considering the resistance value of the coolant. Accordingly, it is possible to accurately detect electrical leakage.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram showing a fuel cell and an electrical leakage detection apparatus for a fuel cell according to an embodiment of the invention;

FIG. 2 is an equivalent circuit showing an electric configuration of a fuel cell module;

FIG. 3 is a flowchart showing operation of detecting a resistance value of coolant; and

FIG. 4 is a flowchart showing operation of detecting electrical leakage.

### DETAILED DESCRIPTION OF THE EXEMPLARY EMBODIMENTS

Hereinafter, description will be made of an electrical leakage detection apparatus for a fuel cell according to an exemplary embodiment of the invention, with reference to the drawings. A configuration according to the embodiment is exemplary, and the invention is not limited to the configuration according to the embodiment.

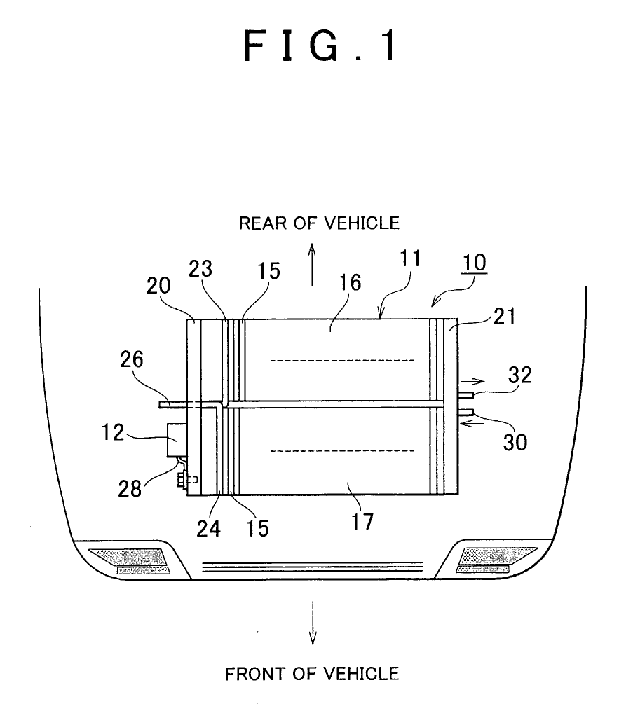

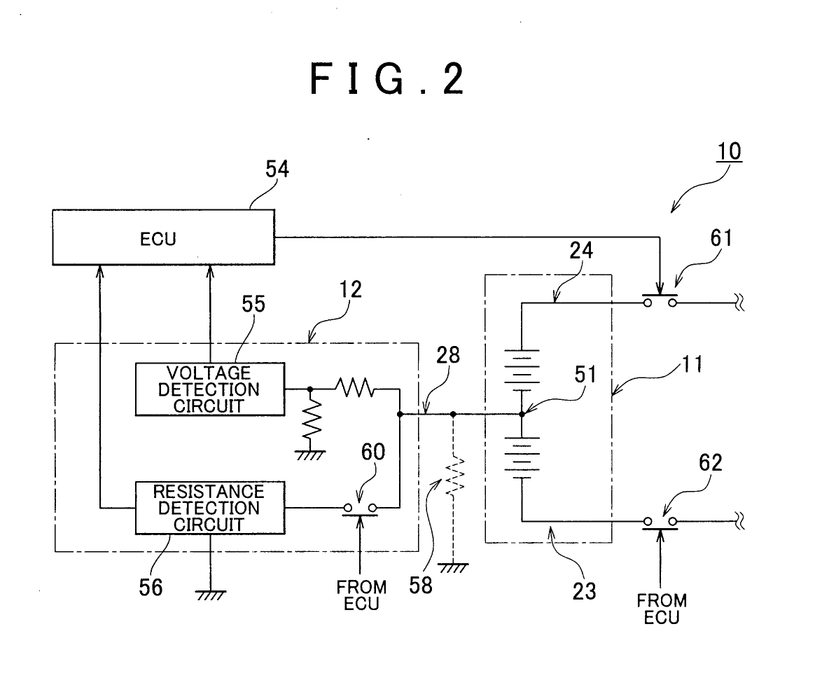

FIG. 1 is a schematic plan view showing a fuel cell and an electrical leakage detection apparatus for a fuel cell (hereinafter, referred to as “a fuel cell module”) according to the embodiment of the invention, as seen from above the vehicle. A fuel cell module 10 includes a fuel cell stack 11, an electrical leakage detector 12, and an electric control unit (hereinafter referred to as “ECU”) (refer to FIG. 2).

The fuel cell stack 11 is composed of two cell stacks 16 and 17 that are arranged in parallel. Each of the cell stacks 16 and 17 is a stack body formed by stacking plural cells 15 in series (in a lateral direction in FIG. 1). Each of the cells 15 includes a unit cell (not shown) and separators (not shown). Also, the unit cell has a sandwich structure in which an electrolyte is sandwiched between two electrodes, that are, a fuel electrode and an air electrode.

End plates 20 and 21 that are made of metal are provided at both end portions of the cell stacks 16 and 17. That is, the end plates 20 and 21 are provided at a left end portion and right end portion in FIG. 1, respectively. The cell stacks 16 and 17 are pressed in a direction in which the unit cells are stacked (hereinafter, referred to as “the cell stacked direction”), and fixed between both the end plates 20 and 21, using a fastening member (not shown) that is made of conductive metal.

The fuel cell stack 11 is supplied with coolant for removing heat generated by the cell stacks 16 and 17. For example, the coolant is cooled by a radiator (not shown), and is circulated by a coolant pump (not shown) or the like. The radiator is connected to an inlet 30 and an outlet 32. The coolant flows into the fuel cell stack 11 through the inlet 30, and is circulated in the fuel cell stack 11 to remove heat generated by the cells. Then, the coolant flows out of the fuel cell stack 11 through the outlet 32, and returns to the radiator.

The cell stacks 16 and 17 are configured to include the same number of the cells 15, and to generate the same voltage. Also, the cells 15 constituting the cell stacks 16 and 17 are stacked such that a polarity on each side of the cell stack 16 is opposite to a polarity on each side of the cell stack 17. That is, in this embodiment, the cells 15 constituting the cell stack 16 are stacked such that the cell stack 16 has a positive polarity in a right side thereof, and a negative polarity in a left side thereof in FIG. 1. The cells 15 constituting the cell stack 17 are stacked such that the cell stack 17 has a negative polarity in a right side thereof, and a positive polarity in a left side thereof in FIG. 1. The end portion of the cell stack 16 on the end plate 21 side is electrically connected to the end portion of the cell stack 17 on the end plate 21 side. With this configuration, the cell stacks 16 and 17 are electrically connected in series, and thus a desired high voltage can be obtained. Hereinafter, when a voltage applied to each portion in this embodiment is described, this value of the desired high voltage is used.

An electrode of a cell positioned at the end portion of each of the cell stacks 16 and 17 on the end plate 21 side contacts the end plate 21. Accordingly, the end plate 21 has an intermediate electric potential in the fuel cell stack 11.

An end portion electrode 23 of the cell stack 16 is positioned at the end portion of the cell stack 16 on an end plate 20 side. An end portion electrode 24 is positioned at the end portion of the cell stack 17 on the end plate 20 side. In this embodiment, the electrode 23 of the cell stack 16 is a negative electrode, and the electrode 24 of the cell stack 17 is a positive electrode. Each of the electrodes 23 and 24 has an L-shape. That is, each of the electrodes 23 and 24 is bent so as to extend in the cell stacked direction at a boundary position between the cell stacks 16 and 17 (that is, a center portion of the fuel cell stack 11 in a fore-and-aft direction of the vehicle). A portion of each of the electrodes 23 and 24, which extends in the cell stacked direction, passes through a hole formed in the center portion of the end plate 20 in the fore-and aft direction of the vehicle, and protrudes from the end plate 20 toward a side of the vehicle. Thus, an end portion of each of the electrodes 23 and 24 is used as a terminal 26. Also, a portion in the vicinity of the end plate 21 has an electric potential that is intermediate between an electric potential of the negative electrode 23 and an electric potential of the positive electrode 24 (hereinafter, simply referred to as “the intermediate electric potential”).

When the coolant is circulated in the fuel cell stack 11, the coolant contacts the electrodes of the cells 15 in the fuel cell stack 11. Therefore, the coolant is influenced by an electric potential of the electrodes. In this embodiment, the end plate 21 is provided with the inlet 30 and the outlet 32, and the end plate 21 contacts the electrode of the cell 15. Therefore, the coolant has an electric potential that is the same as that of the portion in the vicinity of the end plate 21. Thus, since the portion in the vicinity of the end plate 21 has the intermediate electric potential, the coolant also has the intermediate electric potential.

The electrical leakage detector 12 is fixed to the end plate 20. A cable 28 extends from the electrical leakage detector 12. An end portion of the cable 28 is fixed to the end plate 20. As described above, both the end plates 20 and 21 are connected to each other using the fastening member made of conductive metal. Therefore, the end plate 20 also has the same electric potential as that of the end plate 21 on the opposite side.

The fuel cell stack 11 is insulated from the vehicle that serves as a ground. The outlet 32 and the inlet 30 for the coolant are connected to the fuel cell stack 11 using an insulative pipe. That is, the outlet 32 and the inlet 30 are insulated from the end plate 21. With this configuration, leakage current is closely related to a resistance value of the coolant.

FIG. 2 is an equivalent circuit showing an electric configuration of the fuel cell module 10. A function of each portion will be described with reference to FIG. 2.

The electrical leakage detector 12 is connected to an intermediate electric potential portion 51 (the end plate 20) of the fuel cell stack 11. The intermediate electric potential portion 51 is connected to a voltage detection circuit 55 and a resistance detection circuit 56 in the electrical leakage detector 12. An output terminal of each of the voltage detection circuit 55 and the resistance detection circuit 56 of the electrical leakage detector 12 is connected to an input port (not shown) of the ECU 54. That is, the ECU 54 detects a voltage of the coolant which has the electric potential equivalent to that of the intermediate electric potential portion 51 in the fuel cell stack 11, using the electrical leakage detector 12.

With this configuration, the electrical leakage detector 12 detects the voltage of the coolant delivered to the fuel cell stack 11 (hereinafter, referred to as “the coolant voltage”), thereby detecting occurrence of electric leakage.

Hereinafter, description will be made of a flow of electric current in a case where electrical leakage occurs in the fuel cell module 10. As an example, description will be made of a case where electrical leakage occurs in the negative electrode 23 of the fuel stack 11. In this case, electric current flows between the electrode 23 and the coolant. In FIG. 2, the coolant is represented by a resistance 58. Hereinafter, the coolant will be referred to as “the coolant resistance 58”. That is, a circuit connecting the negative electrode 23 of the fuel stack 11 with the coolant resistance 58 is formed, and leakage current flows in the circuit.

In order to detect occurrence of such electrical leakage, the voltage detection circuit 55, which is an internal circuit of the electrical leakage detector 12, is connected to the intermediate electric potential portion 51, and measures the voltage of the intermediate electric potential portion 51. The voltage detection circuit 55 notifies the ECU 54 of the detected voltage.

Meanwhile, the resistance detection circuit 56, which is an internal circuit of the electric leakage detector 12, measures a resistance value of the coolant resistance 58. The resistance detection circuit 56 is connected to the intermediate electric potential portion 51 via a coolant resistance value detection relay 60 (hereinafter, referred to as “the relay 60). The resistance detection circuit 56 includes an internal voltage portion. Using this voltage of the internal electric potential portion 51, the resistance detection circuit 56 accurately measures the resistance value of the coolant resistance 58. Then, the resistance detection circuit 56 notifies the ECU 54 of the measured resistance value of the coolant resistance 58. The relay 60 is controlled by the ECU 54. When detection of the resistance value is started, the relay 60 is closed (that is, the relay 60 is turned on).

The ECU 54 includes a CPU, memory, an input/output interface, and the like. The ECU 54 executes a control program stored in the memory using the CPU, thereby performing an electrical leakage detection control and a coolant resistance value detection control. Hereinafter, description will be made of the aforementioned two controls performed by the ECU 54.

Coolant Resistance Value Detection Control

The ECU 54 periodically measures the resistance value of the coolant resistance 58. This is because the voltage of the coolant (the voltage of the intermediate electric potential portion 51) is used for detection of electrical leakage, and the voltage of the coolant is proportional to the coolant resistance 58. On the basis of the measured resistance value, the ECU 54 calculates a threshold value of the coolant voltage, which is used for the electrical leakage detection control. The threshold value is used also as a threshold value of the voltage of the intermediate potential portion 51, and is equivalent to the voltage threshold value according to the invention. Hereinafter, the threshold value will be referred to as “the voltage threshold value”. The voltage threshold value is calculated such that the voltage threshold value is increased with an increase in the coolant resistance value. The voltage threshold value may be calculated based on a relationship between the voltage threshold value and the coolant resistance value such that a value of leakage current in the coolant becomes equal to or smaller than a predetermined threshold value. In this calculation, for example, the formula based on Ohm's law, Voltage=Electric Current×Resistance is used. The predetermined threshold value of leakage current that is used in this case may be stored in the memory in the ECU 54.

Another reason why the ECU 54 periodically measures the resistance value of the coolant resistance 58 is as follows. As the coolant flows between the radiator and the fuel cell stack 11, for example, metal ions leak out of a metal pipe through which the coolant flows, which increases an electric conductivity of the coolant. That is, as the coolant is used, the electric resistance thereof is reduced, and electric current becomes likely to flow in the coolant. Thus, since the resistance value of the coolant is periodically measured, the voltage threshold value can be appropriately calculated each time the resistance value of the coolant is measured. As a result, the electrical leakage detection control can be appropriately performed. A control portion of the ECU 54, which performs the aforementioned coolant resistance value detection control, is equivalent to an example of the correction portion according to the invention.

Description of a Flow of Operation of Detecting the Coolant Resistance Value

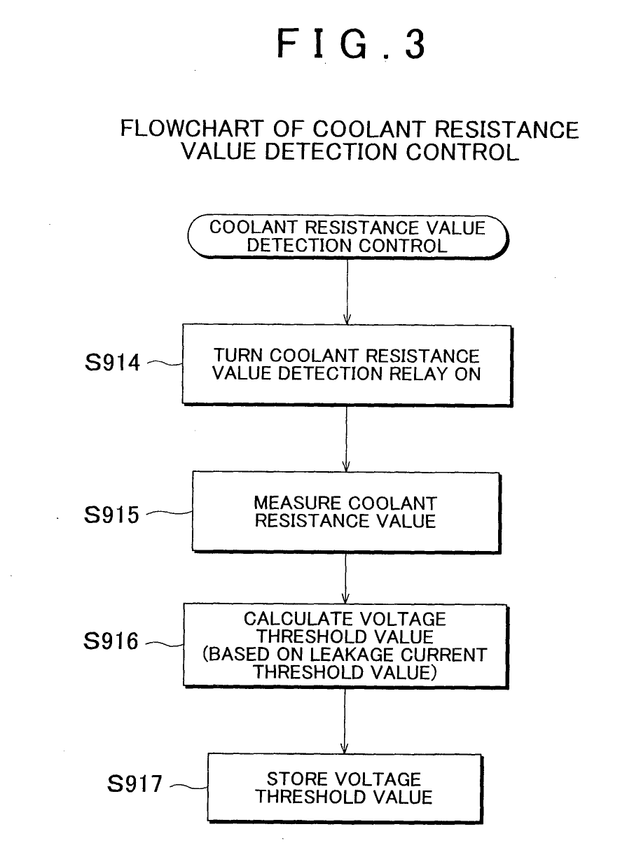

FIG. 3 is a flowchart showing the coolant resistance value detection control performed by the ECU 54. The ECU 54 periodically performs the coolant resistance value detection control. When the coolant resistance value detection control is started, the ECU 54 closes the coolant resistance value detection relay 60 (S914). After the relay 60 is closed, the resistance detection circuit 56 of the electrical leakage detector 12 measures the resistance value of the coolant. Then, the ECU 54 is notified of the measured resistance value (S915). Using the resistance value, the ECU 54 calculates the voltage threshold value (S916). Then, the voltage threshold value is stored in the memory in the ECU 54.

Electrical Leakage Detection Control

The ECU 54 detects electrical leakage in the fuel cell module 10. When the ECU 54 detects electrical leakage, the ECU 54 opens fuel cell relays 61 and 62, that is, the ECU 54 turns off the fuel cell relays 61 and 62, thereby providing disconnection of cables. The ECU 54 detects electrical leakage by comparing the measured voltage of which the ECU 54 is notified by the voltage detection circuit 55 with the voltage threshold value which is stored in the memory in the ECU 54. The control portion of the ECU 54, which performs the aforementioned electrical leakage detection control, is equivalent to an example of the electrical leakage determining portion according to the invention.

Description of a Flow of Operation of Detecting Electrical Leakage

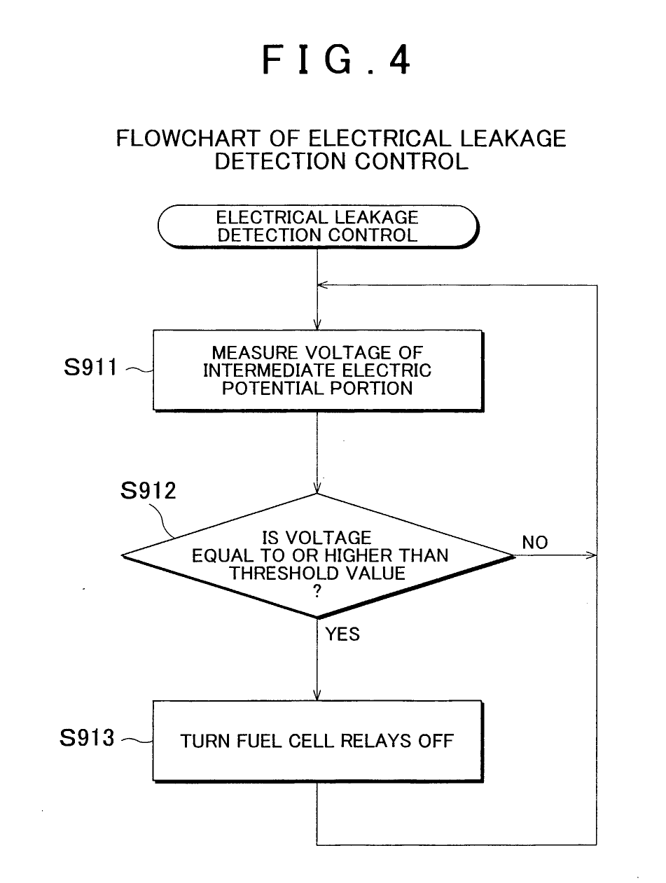

FIG. 4 is a flowchart showing operation of detecting electrical leakage performed by the ECU.

The voltage detection circuit 55 constantly or periodically measures an electric potential difference between the intermediate electric potential portion 51 and a ground (S911). That is, the voltage detection circuit 55 constantly or periodically measures the voltage of the intermediate electric potential portion 51, and the ECU 54 is constantly or periodically notified of the measured voltage (S911). When the ECU 54 is notified of the measured voltage by the voltage detection circuit 55, the ECU 54 compares the voltage threshold value which is stored in the memory with the measured voltage of which the ECU 54 is notified (S912). When the measured voltage is equal to or higher than the voltage threshold value as a result of comparison (“YES” in step S912), the fuel cell relays 61 and 62 are opened, that is, the fuel cell relays 61 and 62 are turned off. When the measured voltage is lower than the voltage threshold value as a result of comparison, the ECU 54 waits for notification about the voltage that is measured next time.

### Effects of the Embodiment

As described above, the fuel cell module 10 according to the embodiment of the invention includes the fuel cell stack 11; the voltage detection circuit 55 that detects the voltage of the coolant flowing in the fuel cell stack 11; the resistance detection circuit 56 that detects the resistance value of the coolant flowing in the fuel cell stack 11; and the ECU 54 that controls these circuits. The ECU 54 calculates the voltage threshold value based on the resistance value detected by the resistance detection circuit 56. When the voltage detected by the resistance detection circuit 56 is equal to or higher than the voltage threshold value, the ECU 54 determines that electric leakage has occurred, and opens the fuel cell relays 61 and 62.

Thus, it is possible to calculate the voltage threshold value according to a change in the electric conductivity of the coolant, which is caused by deterioration of the coolant, and to detect electrical leakage using this voltage threshold value. That is, it is possible to maintain an electrical leakage detection level, irrespective of deterioration of the coolant.

### MODIFIED EXAMPLE

In the aforementioned embodiment of the invention, the intermediate electric potential portion 51 of the fuel cell stack 11 is connected to the resistance detection circuit 56, and the resistance value of the coolant resistance 58 is detected. However, an insulation resistance of the entire high-voltage circuit (that is, the entire fuel cell stack 11) may be measured.

Thus, in the vehicle in which the fuel cell module 10 is installed, it is possible to measure a total resistance value which is a total of resistances in all portions. Accordingly, the voltage threshold value is decided based on the total resistance value, and electrical leakage can be accurately detected using this voltage threshold value.

Also, in the embodiment of the invention, the coolant resistance value detection control is periodically started. However, the resistance value may be detected before the fuel cell generates electric power. That is, the ECU 54 may detect the resistance value by closing the coolant resistance value detection relay 60 before the fuel cell relays 61 and 62 are closed.

Thus, it is possible to obtain the accurate coolant resistance value using only the internal voltage of the resistance detection circuit 56, irrespective of the high voltage generated by the fuel cell stack 11.

Also, in the embodiment of the invention, the coolant resistance value detection control and the electrical leakage detection control are performed by the ECU 54 which is provided separately from the electrical leakage detector 12. However, an ECU may be provided inside the electrical leakage detector 12, and the aforementioned controls may be performed by the ECU. Further, although the aforementioned controls are performed by the ECU 54 that is the microcomputer in the embodiment of the invention, the aforementioned control may be performed by a digital circuit or an analog circuit.

The configurations described above may be combined as required.

What is claimed is:

1. An electrical leakage detection apparatus for a fuel cell comprising:
a voltage detector that detects a voltage applied to coolant flowing in a fuel cell;
an electrical leakage determining portion that determines that electrical leakage has occurred when the voltage detected by the voltage detector is equal to or higher than a voltage threshold value;
a resistance value detector that detects a resistance value of the coolant in the fuel cell; and
a correction portion that corrects the voltage threshold value such that the voltage threshold value is increased with an increase in the resistance value detected by the resistance value detector.

2. The electrical leakage detection apparatus according to claim 1, wherein the resistance value detector detects the resistance value before the fuel cell generates electric power.

3. The electrical leakage detection apparatus according to claim 1, wherein the correction portion calculates the voltage threshold value based on the resistance value detected by the resistance value detector and a predetermined leakage current value.

4. The electrical leakage detection apparatus according to claim 1, wherein the fuel cell includes a first cell stack, and a second cell stack that is electrically connected to the first cell stack;
the first cell stack includes a first coolant passage through which the coolant flows in the first cell stack, and the second cell stack includes a second coolant passage through which the coolant flows in the second cell stack, and which is connected to the first coolant passage; and
the voltage detector detects an electric potential that is intermediate between an electric potential of the coolant that flows into the first cell stack, and an electric potential of the coolant that flows out of the second cell stack.

5. An electrical leakage detection method for a fuel cell, comprising:
detecting a voltage applied to coolant flowing in a fuel cell;
determining that electrical leakage has occurred when the detected voltage is equal to or higher than a voltage threshold value;
detecting a resistance value of the coolant in the fuel cell; and
correcting the voltage threshold value such that the voltage threshold value is increased with an increase in the detected resistance value.
